(19) United States
(12) Patent Application Publication
(10) Pub. No.: US 2011/0136559 A1
(43) Pub. Date: Jun. 9, 2011

(54) Political Persuasion Rating System, Politico: Liberal, Conservative, Evil Ranking

(76) Inventor: Glyn Mason Ottofy, Fort Collins, CO (US)

(21) Appl. No.: 12/634,333

(22) Filed: Dec. 9, 2009

(51) Int. Cl. A63F 9/24; G06Q 99/00; G06Q 50/00; G06Q 90/00; A63F 3/00

(52) U.S. Cl. 463/9; 705/1.1; 705/500; 273/279

(57) ABSTRACT

A process and gaming method for determining whether individuals and leaders are liberal, conservative, or evil (LCE), in their thinking, actions, approach to governing, and life in general. The process is designed to quantify and rate individuals' political persuasion. The invention takes a straight line political scale and bends it into a circular spectrum to express politico positions. This invention uses this spectrum to create a parlor board game or a web based quantitative process/game which can allow live interactive participation. All individuals can be ranked within the liberal, conservative, and evil scale or Politico Spectrum created by this invention. An individual's motives and results must be considered when they fall into the Evil category. The process uses a series of questions, answers, and tests, and the plurality of the responses quantifiably ranks the individual participants within the spectrum.

### FIELD OF INVENTION

This invention relates specifically to a process of determining political/politico thinking and actions. It generally relates to playing a live board game or an interactive web site game about political/politico thinking. Its specific intent is to allow individuals to quantify what theirs' or other individuals' political bent/preference is: (i.e. How Liberal, Conservative, or Evil an individual is). Other specific intents are to teach and educate people on the politico thinking of various individuals and leaders, and help negotiate change in thinking among individual players.

### DISCUSSION OF THE RELATED ART

No specific related patented art found. No existing political/politico straight line scale conversion to circular spectrum found. No existing liberal, conservative, evil rating system exists.

There is an existing conservative-to-liberal rating system used in National Journal documentation for Congressional voting record. This rating system is for congressional members only and not applicable to the general public.

Since 1981, National Journal's annual vote ratings have defined where members of Congress stand ideologically. The ratings rank lawmakers on how they vote relative to each other on a conservative-to-liberal scale in both the Senate and the House. The scores are based on the members' votes in three areas: economic issues, social issues, and foreign policy. The ratings system was first devised in 1981 under the direction of William Schneider, a political analyst and commentator, and a contributing editor to National Journal.

Note: Related non-patented art exists relative to Congressional votes. Congressional votes can be made for various political and financial reasons unrelated to conservative or liberal beliefs. This invention is not limited to just politicians. This invention relates to the population of the world and how all common men in general fit into a political scale. This invention addresses and includes in the debate all historical figures as well as current leaders. The invention relates to subjects and beliefs, which may or may not be reflected in votes, and includes an Evil category for those politico and individuals failing to honor liberty, freedom, and human rights. Numerous other liberal, conservative, or evil thoughts and actions exist which do not require votes. This invention allows contrasts among individuals by a process of measuring political thought and actions.

Various internet sites exist that address liberal and conservative political ranking. No internet sites were found that address liberal, conservative, and evil political thinking in relationship to each other, and no internet site was found comparing and ranking political thinking among living and deceased politico to non-politico.

### SUMMARY OF THE INVENTION

The primary embodiment of the invention is to provide a quantifiable process for individuals to discover, determine, and identify theirs and others relative liberal, conservative, or evil political positions. The Liberal, Conservative, and Evil Spectrum/Scale (LCE Scale/Political Spectrum) uses a quantifiable method of establishing relative positions of individuals' liberal, conservative, or evil (LCE) proclivity. The LCE Scale is used to help navigate through the process or game and helps pin point where individuals fall within the scale relative to others in the game, or other third parties, such as living or deceased political leaders. The process terminates after a period of time and or events which provides enough information for individuals to be placed within the said Politico Spectrum and determine their said Politico Quotient (PQ).

### BRIEF DESCRIPTION OF THE DRAWINGS

The present invention will now be described by way of example with reference to the following drawings in which:

FIG. 1 is an iterative view of the flow drawings from a straight line scale bending to a circular spectrum.

FIG. 2 is a drawing of a completed conversion of the circular spectrum of a Liberal, Conservative, and Evil Scale.

FIG. 3 is a drawing of the Politico Spectrum with the preferred embodiment number of characters/politico figures representing the unit scale.

FIG. 4 is a flow diagram of the computer based process of the Liberal, Conservative, Evil (LCE) Scale/Political Spectrum development, maintenance, and game play.

FIG. 5 is an example addressing the basic Politico Game Scoring method and Politico Quotient (PQ) determination.

### DETAILED DESCRIPTION OF THE INVENTION

The primary goal of the invention process is designed to quantify and rate individuals' political persuasion. An embodiment of this invention provides a board-game based apparatus for identifying, quantifying, debating, and teaching politico thinking and establishing LCE proclivity. This board game approach can be a physical board game, computer program, or web based site. The invention provides a quantification system utilizing questions and answers to establish the political beliefs and actions of individuals playing the game, based on a comparative analysis to current and historic leaders. Among other things, the game is suitable for home play for fun and knowledge, political debate on the internet, or inclusion in classrooms for helping educators to teach political science, economics, social issues, and foreign policy. The game is configured for various modes of play, ranging in objectives and difficulties.

The web site version of the game is designed to be interactive with other players and allow players to contribute to the Politico quantification system of ranking leaders as it evolves over time and also for people to debate various political issues. The computer based process provides the base for politico quantification of individual game players as well as current and historical figures. A computer is used to collect, calculate, and store inputs from internal and external sources to form the basis of playing the politico game on the World Wide Web.

In one embodiment of the invention, the game apparatus includes: a game board having images of historical or current world political leaders. The game board is designed as a circular spectrum dividing the ranking of the political leaders in categories of liberal, conservative, and evil. This embodiment identifies and names the three primary categories on the game board surface: Liberal, Conservative, and Evil. Sub-categories are identified within these primary categories: Liberal (Color coded blue) includes refined categories such as: Leftist and Socialists); Conservative (Color coded red) includes refined categories such as: Right and Libertarian); and, Evil (Color coded black) includes refined categories such as: Fascists, Totalitarians, Despots, Dictators, Mass Murders, Communists, Oppressors).

The political leader images are input into the politico game to represent various positions in the liberal, conservative, or evil ‘scale’, (LCE Scale), or Politico Spectrum/Scale. Each image depicts a relative position within the Politico Spectrum. These relative positions form a basis for discussion and comparison to determine how conservative, liberal, or evil people are. The LCE scale is the backbone of the invention and the process and game is built around the scale.

In the preferred embodiment the LCE Scale is, the Politico Spectrum comprising, a circular spectrum divided into the three major categories with ratings units (LCE numbers) as follows: [A] Liberal: one (1) through seven (7), with these rankings located on the top portion of the board left of center. A rating between one (1) and zero (0) is the ‘highest’ or most desirable liberal rating and seven (7) is the lowest or ‘least’ desirable liberal characteristics. [B] Similarly, the Conservative ratings are: one (1) through seven (7), with these rankings located on top of the board right of center. A rating between one (1) to zero (0) at the top of the board is the position of the most desirable conservative attributes, and seven (7) represents the least desirable conservative characteristics. [C] The Evil category comprises the bottom pie shape of the circular Politico Spectrum, and is divided into numbers one (1) through five (5). The five evil slots, 1 through 5, start with the least evil position (1) and move to the most evil position (5).

Standard Liberal (L), Conservative (C), and Evil (E) definitions and real life positions apply to the process and game. In general positions and policies are Evil if they limit human liberties and freedoms and do not promote human liberties and freedom as a whole. Although motives play a part in Evil determination, it is the results that have the strongest influence. The Evil category can be tempered with the historical time frame that Politico lived in (i.e. Slavery before the civil war).

The rating derived from determining an individual's position (LCE number/unit measurement) is their Politico Quotient (PQ). The PQ is use to do a comparison among individuals similar to the intelligent quotient (IQ) derived from IQ tests.

Each unit position on the Politico Scale equates to a Politico Quotient numerical or alpha numeric designation associated with it and these units of measure are based on political characters' positions within the Politico/LCE Scale through a study and objective observation of historical facts. The preferred method has seven (7) Conservative figures, seven (7) Liberal figures, and five (5) Evil figures corresponding to the LCE Scale (Circular Politico Spectrum), but could consist of any number of units, subunits, and associated figures. These nineteen people/characters represent the preferred LCE Scale and form the baseline of The Politico Spectrum and PQ determination. The characters used in the said Spectrum are well known and highly acclaimed individuals in their particular category. Numerous figures can fall within and between the whole unit presentations and may or may not be displayed. These numerous figures can be identified physically on the face of the board game, by picture cards within the\ board game, or a scroll technique or revolving picture/figure, in the computer based system. These additional leaders can also be represented by fractional or decimal unit numbers falling within the whole unit group measurement.

There are several versions of the process and the game ranging from mature play to beginners and student versions. All versions focus on determining individual positions on the Politico Spectrum (Circular LCE Scale) some being more overt then others. The less mature or beginner game version of play is subtle in its approach in determining individual positions within the Politico Spectrum. The beginner game play focuses on winning the game and in doing so the players will derive a position on the LCE Scale while thinking about mature subjects. The mature play is focused on individual positions within the Politico Spectrum and having players debate their differences in their answer to politico questions and sway or move opponents thinking.

One individual or several individuals can use this invention's process and play the game. One or more individuals can follow the mature game process or beginner/student play process to move around the boards' positions and answer the questions as they are presented. A spin of a wheel, roll of dice, or other means can be used to make moves. There are various spaces around the outside of the Circular LCE Spectrum as well as images located in the three categories: [Preferred embodiment] seven (7) in Liberal, seven (7) in Conservative, and five (5) in Evil. Each space can relate to a question or action or both that leads to determining final positions within The Politico Spectrum. The sum of the answers to questions and gaming milestones are kept on a score sheet/card or in the computer memory and are used to calculate final positions on the LCE Scale and game winners. There are several modes of game play and methods of determining game winners. The process is over upon completion of one or more events depending on the mode of play.

There are several scoring options and difficulty levels that can be kept while playing the process. The primary scoring options in the preferred embodiment version include:

I. My relative position within The Politico Spectrum—[Liberal: ‘L one’ (L1) through ‘L seven’ (L7); Conservative: ‘C one’ (C1) through ‘C seven’ (C7); and, Evil: ‘E one’ (E1) through ‘E five’ (E5)]. A calculation is accomplished at the end of the process through use of the Politico Quotient (PQ) formula, which provides a PQ number and a relative position within The Politico Spectrum (LCE Scale).

II. How do others fit in The Politico Scale—in the mature, advanced, or adult version of the game the goal is to determine how follow players and other individuals and leaders fit into the LCE Scale, or how liberal, conservative, or evil is their political bent. The process requires each player to be the protagonist for their political leadership traits, which may or may not be defined until the end of the process.

III. The Supreme Politico Leader—The leaders/winners can be determined in various ways, including collecting game board tokens, earning points by answering questions, or making game board apparatus milestones. The winner can become the World supreme dictator for life or until he or she is removed by coupe. The “Politico Leader” is elected for term period of years. These various methods of scoring and winning can be accomplished through game play by answering questions, the ‘luck of the draw’, or by landing on a specific combination of key spaces on the game board.

IV. Debate and Education—One of the primary goals of the advanced version of the embodiment is to measure movement in individual political beliefs as a result of debating and negotiating positions on various issues. This process requires a mature approach to positions and truth in movement in ones thinking. This also requires objective and open thinking and critical self analysis in determining the “winner”. This approach is relative to attaining a movement in thinking and a concession by the person changing their position. All versions include the educational value of learning more about politico leaders, one's self, and other individuals playing the game.

In other versions of the process for the less mature players, or advanced players who already know their relative position in the LCE Spectrum, the individual game goals can be increased and defined by reaching various milestones, by obtaining tokens, or obtaining political images; and becoming the “Politico Leader”, by accomplishing a series of events. These processes are secondary to the primary process of determining individuals LCE Ranking within the LCE Spectrum, but add dimension, interest, and advanced educational value to the gaming process.

The basic or elemental method of play centers on players determining their position as well as other individual's positions on the LCE Spectrum. Players use the invention to determine their liberal, conservative, or evil thinking relative to others and relative to the base standard as established in the (LCE Scale/Politico Spectrum). This elemental process is true for all versions of play. In the advanced method of play determining other player's position in the LCE Spectrum is the primary objective along with creating movement in their relative position. Other versions are more subtle about the LCE Spectrum position and may focus more heavily on the board play to create interest, educational value, and to determine individual finish positions. This subtle focus is true in the beginner's version for children and young adults that do not necessarily have positions on all facets of political thinking or behavior. The board game allows for introduction into complex questions that younger individuals may not have formed opinions on.

Questions, answers, and relationship to the LCE Spectrum through quantitative development: The LCE Rating Spectrum is developed through a series of questions and answers. Each question relates to a current or historical political issue on how to govern. The number of potential questions is large and limited only by the potential number of political and governing issues that exist in current and historical thought. There are various answers to each question. These answers represent real life approaches to these governing issues. The answers to each question have correlating numbers that are tied to the LCE Spectrum rating system as identified in and consistent with the preferred embodiment and primary scoring process above (Liberal: L1 through L7; Conservative: C1 through C7; and Evil: E1 through E5).

Tokens, political face cards, and movement around board game: The spaces on the board are related to real world governing issues, problems, and implementations. The tokens and character face cards relate to real life issues and people in leadership, governing, and heads of state. The spaces provide directions, questions, and options based on real life situations. Through a process of following the directions on the spaces players collect tokens, political face cards, while answering questions that contribute to their LCE Rating/Rank. The LCE rating is the position or number that individual's obtain as they score their answers. The plurality of these ratings ultimately becomes the Politico Quotient (PQ) of an individual. The invention embodies the process of rating. There are numerous methods and number ranges that can be used to score and obtain an individuals' PQ, but the preferred method in the preferred embodiment is based on a plurality of scores derived from the results of the questions asked.

LCE Rank Scoring System and determination of an individual's Politico Quotient (PQ) in the preferred embodiment: Separately, add all Liberal Scores (LS) (liberal points from individual answers) and all the Conservative Scores (CS) from answers. Subtract the smaller of the two, LS or CS, scores from the larger of the scores, and derive the “L-C” score/number. Divide the “L-C number” by the combined total number of ‘L’ and ‘C’ answers. This number is the Politico Quotient (PQ) for that individual. However, if the answer to any question(s) falls in the Evil category then that individual has an Evil PQ equivalent to the largest Evil number (e.g. if a person has an Evil scores of E1, E3, and E5, among other Liberal and Conservative scores, then their PQ is E5. In other words, if a person has one evil characteristic then they have an Evil Politico Quotient. An individual has an Evil PQ if they have any Evil answers. Once an individual has crossed the line into the Evil category, on any subject matter relating to their approach to governing, they can not be considered either Liberal or Conservative; and, they are by definition Evil.

### DETAILED DESCRIPTION OF THE PREFERRED EMBODIMENTS

Game Play Overview: The basic mode of play uses all the basic processes presented in the claims of this invention. However, several options of play exist and these versions can be combined and accomplish the primary intent of the invention to determine an individual(s) Politico Quotient (PQ)/Political Quotient (PQ), debate political issues, and have fun trying to win a game while learning about politics among others issues. Politico Quotient and Political Quotient are synonymous. At the end of the game, which can be determined in various ways, the scores are averaged to determine a persons' PQ. Also, at the end of the game the ‘winners’ are determined in various ways. Two scores can be obtained: one to determine individual PQ and another to determine winners.

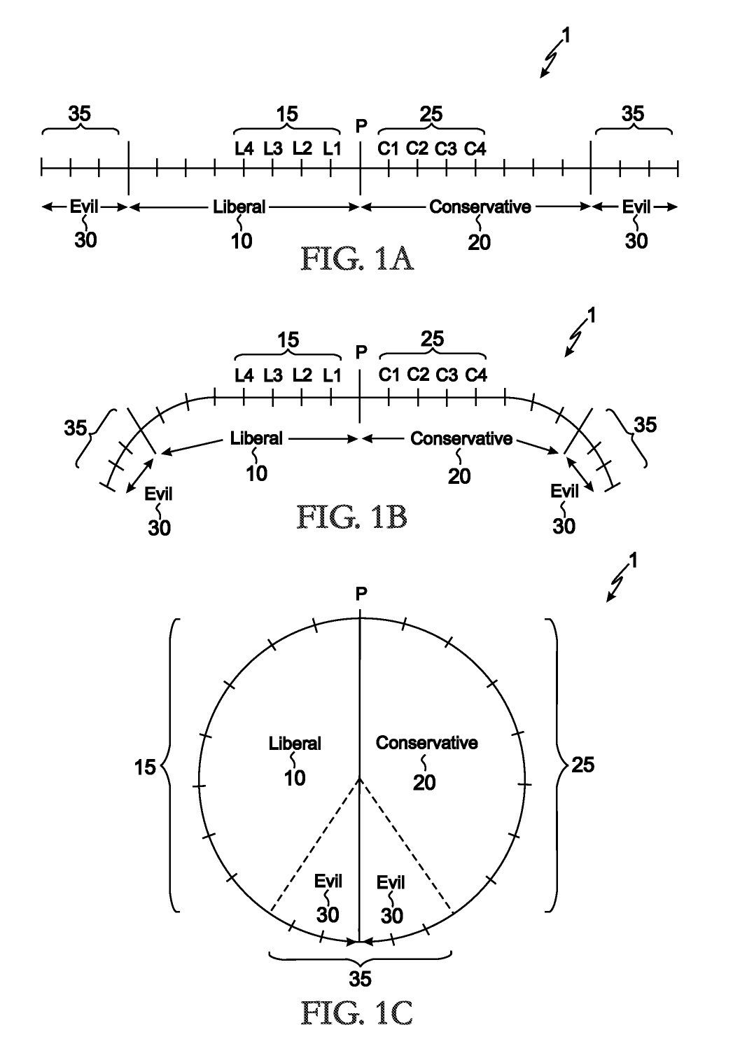

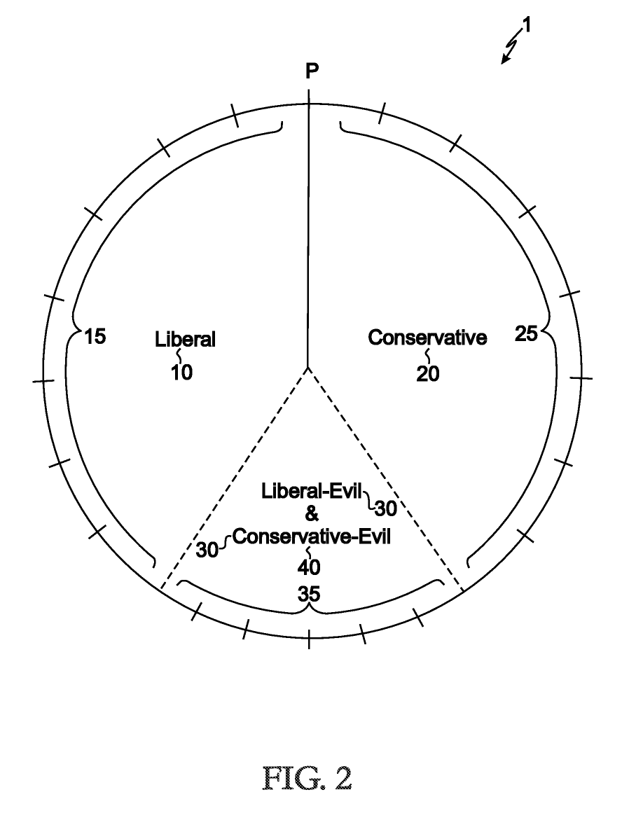

The basis of the play is formed by the Politico Spectrum/LCE Scale (e.g. all points left of center liberal, and all points right of center conservative, and ultimately both fade into ‘evil’ at there extremities (see FIG. 1A), or it can be a circular spectrum (see FIG. 2). The scale can be weighted in various ways to highlight how Liberal (FIGS. 1, 2, 3, & 4 [10]); Conservative (FIGS. 1, 2, 3, & 4 [20]); or, Evil (FIGS. 1, 2, 3, & 4 [30]) an individual is. The Evil category is derived in the circular spectrum when the Liberal and Conservative evil categories converge (see FIG. 1 [30]) and become indistinguishable (see FIG. 2 [40]) as to the evils origin.

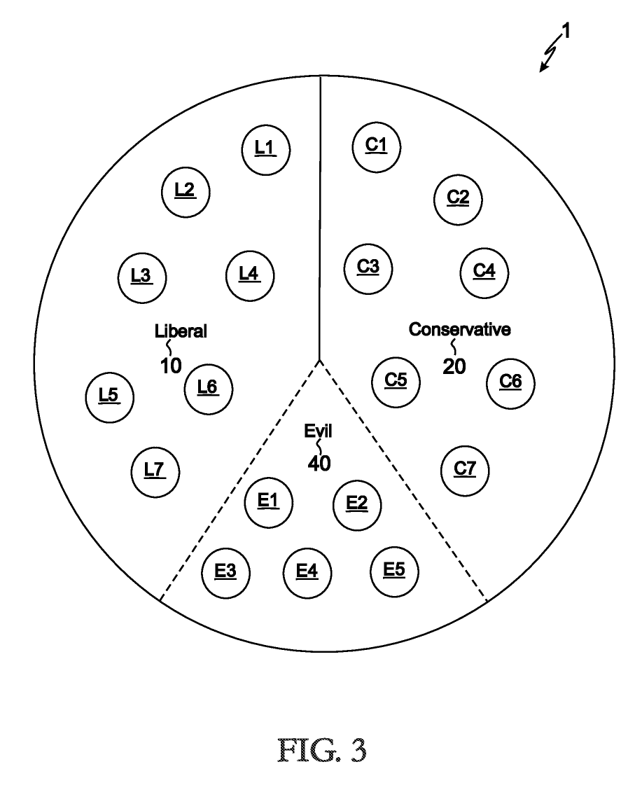

The said Politico Spectrum is comprised of categories as follows: Conservative or “Right Wing” category, (preferred embodiment unit scale: Red C1 through Red C7, see FIGS. 1 & 3 [25]); II. A Liberal or “Left Wing” category, (preferred embodiment unit scale: Blue L1 through Blue L7, see FIGS. 1 & 3 [15]); and, III. An Evil category (preferred embodiment unit scale: Black E1 through Black E5, see FIGS. 1 & 3 [35]). The lower the number is, or closer to the unit number zero (“0”) that the Red (Conservative) and Blue (Liberal) numbers are the “more preferable”, or closer to “PERFECTION” (P) (see FIG. 3), the Conservative or Liberal is within their class. Rankings or ratings outside the Liberal or Conservative scale categories fall into the Evil ranking scale (preferred embodiment unit scale: Black, E1 through Black, E5). These Evil leaders/individuals fall out of the Liberal—Conservative Spectrum and into the realm of evil dictators, oppressors, despots, Marxists, communists, and others that do not recognize individual freedoms and rights. The highest unit scale, E5, in the evil category represents the most evil or devil like ranking.

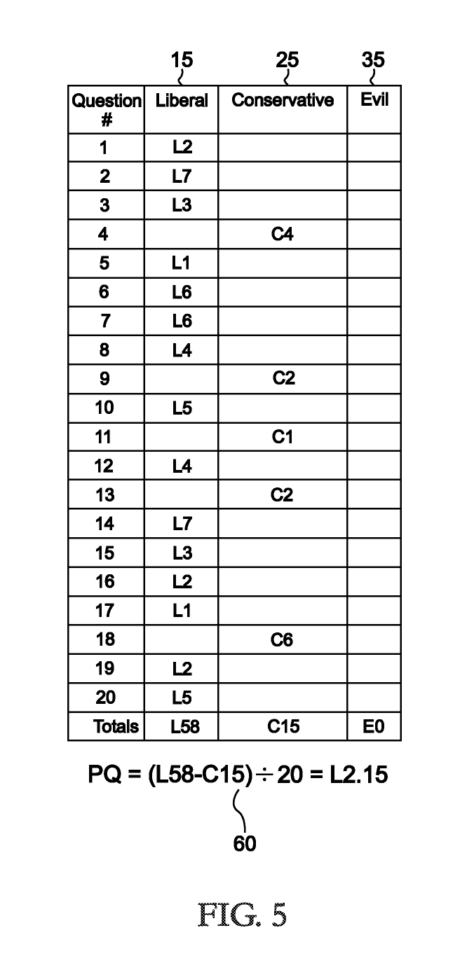

The determination of a persons' Politico Quotient (PQ) or Political Quotient (PQ) in the preferred embodiment is accomplished in accordance with the PQ formula (see FIG. 5[60]) that averages Liberal and Conservative scores to derive a persons PQ (see FIG. 5[15]&[25]). If however, any answer(s) by an individual that fall within the Evil category force that person into an Evil PQ that is equivalent to the largest of their Evil answers (see FIG. 5[35]). This process weight's the PQ of any individual with Evil tendencies (i.e. any Evil Score) to their highest or worst Evil rating and all Liberal or Conservative scores are not considered in determining their PQ. This is because the evil category is so negative and onerous to the overall political thinking of an individual that any evil answer(s) negate any independent Liberal or Conservative issue ratings and drives the individual to an Evil PQ.

The politico figures within the said Politico Spectrum represent a relative relationship to each other, with the more favorable (closer to perfection) politico positions occupying the lower numbered positions on their respective scales [i.e. the closer to position ranking of zero (0), or Perfection (see FIGS. 1 & 2 [P]) the more favorable the ranking in both the liberal or conservative positions. Conversely, the closer the ranking is to seven (7) in the preferred embodiment, the less favorable the politico characteristics. The evil category is less evil closer to the lower end of its category, or one (1), and more evil toward the higher end of the rank or five (5)]. An individual with a seven ranking in either the conservative or liberal categories is bordering on, but just outside, the Evil category.

The preferred method is to have independent third parties debate and by plurality of thought place politico in positions within The Politico Spectrum (LCE Scale) and, therefore, provide a living data base that continues to evolve, change, and be added to with time, events, and new politico. This process invites debate, and the computer based system provides for interaction to help resolve differences of opinion and draw a consensus. Thus, The Politico Spectrum (LCE Scale) is a living process that is based on a plurality of inputs. As individual politico thinking changes so potentially does their position within The Politico Spectrum. The politico's are voted into their respective positions within The Politico Spectrum, and Individual positions within The Politico Spectrum represent a consensus of the plurality of the people that have provided input.

The initial positioning of individuals within The Politico Spectrum is the creation of the inventor and forms the basis for discussion and investigation of where historical leaders, current leaders and political thinkers fit into The Politico Spectrum. Therefore, the inventor filters this initial preferred embodiment. Also, this creation forms the basis for individuals (non-politico participants or the average person) to determine where they fit within The Politico Spectrum. The Politico Spectrum invention is designed on real life positions and events. All current and historical world politico figures are eligible to be rated within the Politico Spectrum. Several versions of the embodiment can exist simultaneously that are weighted more heavily by Liberal, Conservative, or other inputs. These versions may not be filtered by the inventor and are identified as such.

In the preferred embodiment the numerical round scale flows counter clockwise or clockwise and is defined counter clockwise as follows: (Liberal range—12 o'clock to approximately seven (7) o'clock; Evil range—from seven (7) o'clock to five (5) o'clock; and, Conservative range—approximately, five (5) o'clock to twelve (12) o'clock), (see FIG. 3). The scale divisions create intersections along the North-South (12 to 6 o'clock) diameter of the circle approximately three fifths (⅗^{th}) of the way from the twelve o'clock position heading directly down to six (6) o'clock position. The point and lines extending from the intersection creates a “pie radius” shape widening to the bottom. This “center point” and “line type radius”, divide the continuum circle into respective: liberal, conservative, and evil “pie like shapes” dividing the circle. The division looks similar to a standard ‘peace sign’ when complete with the three internal sections/categories representing the three basic political divisions within The Politico Spectrum (see FIG. 2).

In the preferred embodiment the numerical scale consists of seven (7) Conservative and seven (7) Liberal units with five (5) Evil units, [L1-L 7; C1-C7; or, E1-E5]. The range of the scale can vary from the preferred measurement to numerous other possible measurements, and maintain the same effect as the preferred embodiment measurement.

There are various sub-categories within The Spectrum. The sub-categories consist of, but are not limited to: (A) Liberal: very liberal, mildly liberal, leftist, left wing, socialist, progressive, judicial activism, governmental control; (B) Conservative: very conservative, mildly conservative, rightist, libertarian, constructionist, less governmental control; (C) Evil (limiting liberty, freedom and human rights): mildly evil, severely evil, slavery, oppression, torturer, terrorist.

The Politico questioning that is used to create The Politico Spectrum is divided into three basic categories: economic issues, social issues, and foreign policy. The answers to the questions have numerical values which represent a position on the LCE Scale.

In the preferred method, the participants travel around the board by rolling dice or using a spin of a wheel. In one advanced version of play the participants select the method of how they will approach the game: A. Go for Dictator by ‘force’; or, B. Try to win by being elected The Supreme Politico (receiving votes through accomplishing board game tasks). These methods of play are secondary to the primary process of determining LCE Ranking within The Politico Spectrum, but add dimension, interest, and educational value to the process and game board apparatus.

In the preferred method, (see FIG. 5 [60]), the Liberal units are first reconciled versus the Conservative units to determine the Liberal/Conservative (LC) measure. Separately, add all Liberal Scores (LS) (liberal points from individual answers) and all the Conservative Scores (CS) from answers. Subtract the smaller of the two, LS or CS, scores from the larger of the scores, and derive the “LC” score/number. Divide the “LC number” by the total number of questions answered. This (alpha-numeric) number is the Politico Quotient (PQ) for that individual and the number is always preceded by an “L” or “C” (Liberal or Conservative bent). However, If there is an Evil answer in an individuals answers then that individual has an Evil PQ equivalent to the largest Evil number (e.g. if a person has Evil scores of E1, E3, and E5, among other Liberal and Conservative scores, then their PQ is E5). Therefore, if a person has one evil characteristic/answer then they have an Evil Politico Quotient. Once an individual has crossed the line into the Evil category, on any subject matter relating to their approach to governing, they can not be considered either Liberal or Conservative; and, they are Evil.

There are several basic versions of play (Modes of Play) in determining the Politico Quotient of individuals as follows:

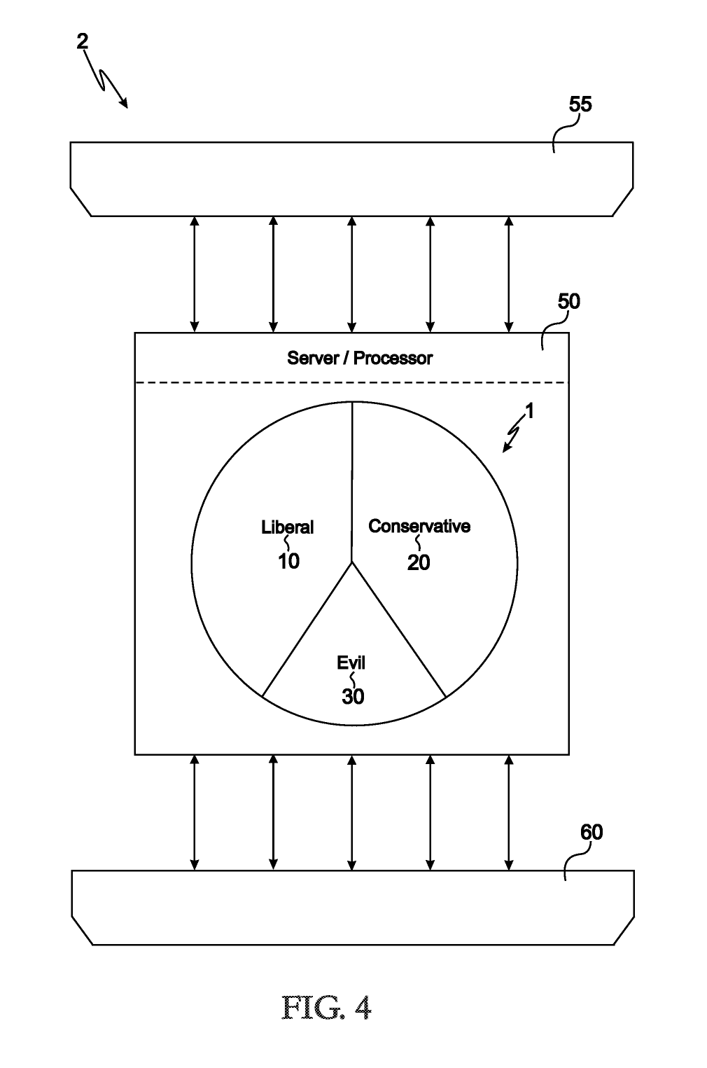

How do politicians, politico, and other leaders around the world fit into The Politico Spectrum? One individual or more can support this version of game play. This version of play contributes to the determination of the positions of Politico within the Spectrum. The World Wide Web (internet) is used for individuals to contribute to the ranking. The inputs from individuals are collected on the computer based internet system, (see FIG. 4). These inputs are used by the invention/computer to update Politico positions on The Politico Spectrum. Scrolls within the unit measurements of the World Wide Web computer based version of this Politico Game can contain all politicos living and deceased. These inputs also form the basis for debate among internet participants on relevant current or historical political issues. These debates or used to further the discussion on how Politicos' approach freedom, liberty, and humane rights; whether or not the Politicos' approach is liberal, conservative, or evil; and which approach is ‘best’ for the human development.

Who am I (what is my PQ): Initially all participants must determine where they fit on the Politico Spectrum? This is the basic and most elementary function of the invention. Individuals determine what their positions are on the Politico Spectrum as defined in the claims above, and each individual determines their politico quotient (PQ). This version of play is designed to move quickly and one or more players can determine their PQ. Each player moves around the board and answers questions and after a predetermined amount of time, or number of questions and tests an individuals' score or PQ is calculated. A person is able to determine which Politico best represents their political thinking. This version can be shortened by directly going to question and answer approach without a gaming aspect.

Who are you (what are other peoples PQ): How do other people fit into The Politico Spectrum? This version can be played along with the, who am I, version. This version concentrates on determining how other people fit into the LCE scale and requires at least two participants simultaneously. Prior to the start of the game each player guesses where each of the other players (or one or more) fit into The Politico Spectrum. These guesses are kept secret or hidden from the other players. After the end of the game the player that has predetermined the closest actual finish position of the other players wins the game. The objective is to be the player that is most accurately able to predetermine where the other players fit into the Spectrum. This necessarily requires individuals playing against others, to not have played against each other before. In the advanced version of this mode of play, if a person is able to change a position through successful debate, the persuasive debater wins the game. This mode requires mature and open minded individuals able to accept logical thought as a reason to change opinions and approaches to governing.

Who Are They (Advanced Game through Role Playing: two are more players): Prior to the start of the game each player chooses a historical or current Politico figure to role play. This version of the game is designed to be more competitive among participants, and this mode can involve deception among other tactics. The players travel the Spectrum Board and answer questions as if they were the historical or current person (i.e. Role Play as though they are that person). The player that is able to determine who the other players are (to the nearest unit of measure) wins the game.

In advanced game modes, players can challenge other players' answers at the end of the game if they think that the role was not played properly and by majority vote a player can be pronounced disqualified because of improperly answered questions. At the end of the game the players declare what role they were playing and other players can declare a formal objection to the role playing. The player who objects gives their rational as to why they believe the role was improperly played and the player challenged responds and then a vote is taken. Majority rules and a split decisions go to the player being challenged.

While the principles of the invention have been described herein, it is to be understood by those skilled in the art that this description is made only by way of example and not as a limitation to the scope of the invention. Accordingly, it is intended by the claims, to cover all modifications of the invention which fall within the true spirit and scope of the invention.

1. A process using a scale or spectrum to rate or rank any individual, living or deceased political figure, or world leader, based on how liberal, conservative, or evil they are/were. The preferred scale or spectrum provides the basis for the Liberal, Conservative, or Evil (LCE) rating process. The scale can vary in shape, size, numbering, and method. Among other scales, it could be a vertical scale, a straight line scale, or it can be a circular spectrum.

2. A process of claim 1 of collapsing a straight line scale into a circular scale which is used to rank politico/political thinking. In the preferred method this invention bends the ends of a straight line scale together and creates a circular scale or spectrum that is used to rank politico and political thinking.

3. A process of claim 1 rating political tendencies, where the preferred LCE scale is a circular spectrum consists of three main classes: Conservative, Liberal, and Evil.

4. A process of claim 1 wherein the preferred LCE Scale contains a rated measure of The Conservative, Liberal, and Evil Spectrum with a politico human picture, caricature, or other figure representing each whole unit or subunit of measure within the three categories (Liberal, Conservative, and Evil). Each picture identifies and represents a numerical point or other unit of the measured scale within each category or class comprising the Politico Spectrum. Each picture or figure is of a historical or current leader, each falls into their particular category, and each identifies and represents the ranking or rating and relative position within The Politico Spectrum.

5. A process of claim 1, wherein the positions of politico within the said spectrum are based on objective historical records and facts, about their political actions and political language from real life situations. Therefore, the said Politico Spectrum is designed to be without bias or prejudice, and to provide a real or true measure of the known and actual characteristics of the politico.

6. A process of claim 1, that helps minimize and preclude any bias or prejudice within the LCE Scale ranking. This is accomplished through judgments derived from third parties, such as educators, historians, class rooms, and web site interaction and processing.

7. A process of claim 1, with a method of evolving and updating the current ranking within the said Spectrum and LCE Scale based on inputs to the current ranking of politico that provides an evolution of ideas and issues. Once the baseline is established for historical figures, the evolving Politico Spectrum inputs apply to living and current leaders that form this baseline.

8. The invention in claim 1 provides the basis for an individual to determine their Politico Quotient or Political Quotient (PQ) and compare to other leaders and individuals. An individuals' PQ is the numeric or alpha numeric number, or other unit measure that is derived after determining their position in the said Politico Spectrum/LCE Scale. The PQ is used to do comparative analysis among individuals to develop an understanding of how they and others approach real life situations and establish a baseline for debate and change.

9. A process and game apparatus (board game, video game, or computer game) comprising: board game type play consisting of “The Politico Spectrum/LCE Scale”, and containing three basic political categories: Liberal, Conservative, and Evil. All living and deceased individuals fit within the Politico Spectrum based on their political actions or thinking.

10. A process and game board apparatus of claim 9, used to determine where individuals fit within “The Politico Spectrum”.

11. A process and game apparatus of claim 9, consisting of a Liberal, Conservative, and Evil spectrum (“LCE Scale”) with sub-categories. These known and documented sub-categories within The Politico Spectrum have a numerical, alpha, or other unit scale representation.

12. A process and game apparatus of claim 9, consisting of living, current, or historical political leaders/character representations which form the basis of discussion of political reviews and rankings. These representations are depicted through pictures or drawings of historical or living political figures and each represent a position or a unit measure on the LCE Scale. An unlimited amount of Politico can represent the various units of measurement within the scale.

13. A process and gaming apparatus of claim 9 containing a circular continuum designed spectrum of claim 3.

14. A process and gaming apparatus of claim 9 containing The Politico Spectrum in claim 1, comprised of three basic categories (Liberal, Evil, and Conservative) forming the interior of the circular continuum.

15. A process and game board apparatus of claim 9, which provides a series of questions on cards or computer screen having multiple choice answers. The answers to these questions represent positions on said Politico Spectrum/LCE Scale. These questions and answers test politico thinking, and through the composite of the answers determines where individuals it into The Politico Spectrum. These questions and answers are derived from events that are taken from real life and the real life response to those events and actions.

16. A process and board game apparatus of claim 9, where participants answer questions and select answers which correspond to a placement or numerical value within The Politico Spectrum. The range of the scale can vary in size and limit.

17. A process and board game in claim 9, where a score is kept and a calculation of rating/ranking within the said Spectrum is made. This calculation can be made after a specified number of questions have been answered, a specified period of time or after another predetermined event or benchmark takes place.

18. A process and board game of claim 9, where participants take turns answering questions while moving their representative icon around the board. Participants land on pictures of historical or current political characters or other spaces on the board or video space, which represent units of The Politico Spectrum and through a series of questions, answers, or tests help to develop their politico score or ranking within the said Politico Spectrum.

19. A process and board game in accordance with claim 9, which includes various versions of play. Each version of the process has a distinct method of completing the process or determining winners of the gaming apparatus including: Election to Supreme Elected Politico Leader or overtaking other participants by becoming the “Politico Dictator” through gaming board knowledge, or force/take over. The objectives of these versions are accomplished by obtaining tokens (e.g. politico gold, silver, and bronze bars, obtaining political images, or meeting other gaming milestones).

20. The invention in claim 9 provides a scoring system process containing Liberal, Conservative, and Evil units of measure. This scoring process reconciles the three basic categories to determine a persons' Politico Quotient (PQ) or Political Quotient (PQ) unit measure. This process can be accomplished in various ways and maintain the same effect. The PQ is defined as the location of an individual within the said Politico Spectrum.
